(19) United States
(12) Patent Application Publication
(10) Pub. No.: US 2024/0357721 A1
(43) Pub. Date: Oct. 24, 2024

(54) SYSTEMS AND METHODS FOR CONTROLLING LIGHTING BASED ON WRITTEN CONTENT ON SMART COATED SURFACES

(71) Applicant: SIGNIFY HOLDING B.V., EINDHOVEN (NL)

(72) Inventors: ABHISHEK MURTHY, ARLINGTON, MA (US); DAKSHA YADAV, BOSTON, MA (US)

(21) Appl. No.: 18/684,864

(22) PCT Filed: Aug. 18, 2022
(86) PCT No.: PCT/EP2022/073077

§ 371 Date: Feb. 20, 2024

Related U.S. Application Data
(60) Provisional application No. 63/236,486, filed on Aug. 24, 2021.

(30) Foreign Application Priority Data
Sep. 13, 2021 (EP) 21196205.5

(51) Int. Cl. H05B 47/105; G06F 3/04883; G06V 30/32

(52) U.S. Cl. CPC H05B 47/105; G06F 3/04883; G06V 30/333; G06V 30/36

(57) ABSTRACT

The present disclosure is generally directed to systems and methods for controlling lighting based on the type of written content on smart coated surfaces. A smart coated surface generates pressure data based on the written content. A feature extractor then extracts features from the pressure data describing the written content. A content classifier then feeds the features into a recurrent neural network, such as a Long Short-Term Memory network to select a content label. A lighting controller then controls luminaires based on the content label and data from additional sensors. In this way, the system controls the luminaires based on the type of the written content without evaluating or decoding the content itself. For example, the system is able to label the content as text based on written patterns without interpreting what the text actually says. Accordingly, the content written on the smart coated surface remains private and secure.

### FIELD OF THE DISCLOSURE

The present disclosure is directed generally to controlling lighting based on written content on smart coated surfaces.

### BACKGROUND

Smart coatings can enable large painted surfaces to become “smart” and sense presence or gestures. These coatings allow users to make mundane objects “smart.” Ordinary furniture, walls in a room, car interiors, can all be turned into Internet of Things (“IoT”) devices, in which they become interfaces for gathering data. This data can be used for a wide range of applications.

Smart coatings are ideally suited for conference rooms where individuals write on walls or whiteboards for brainstorming or other collaborative discussions. However, in such settings, lighting is not typically designed for walls to be used as working surfaces. When the walls are painted with smart coatings and become working surfaces, the lighting may cause glare, reducing visibility. Further, different types of meetings may require different light settings. For example, a brainstorming meeting, where individuals may draw flowcharts and architectural diagrams, may require different light settings as compared to a code review meeting, where individuals may draw checklists or write lines of code. Accordingly, there is a need in the art for controlling lighting in an environment using smart coated surfaces.

### SUMMARY OF THE DISCLOSURE

The present disclosure is generally directed to systems and methods for controlling lighting based on written content on smart coated surfaces. The smart coatings generate pressure data based on the written content. A feature extractor then extracts features from the pressure data describing the written content. A content classifier then feeds the features into a recurrent neural network (RNN) to select a content label. A lighting controller then controls luminaires based on the content label. In this way, the system controls the luminaires based on the type of the written content without evaluating or decoding the content itself. For example, the system is able to label the content as text based only on written patterns, without requiring interpretation or analysis of what the text actually says. Accordingly, the content written on the smart coated surface remains private and secure.

The smart coated surface can be any surface, such as a wall or a whiteboard, coated with smart paint. When a user writes on a smart coated surface, data, based on the pressure exerted during writing, is produced. The data is initially pre-processed and normalized. The data is then split up into a number of sub-sequences. For each sub-sequence, up to three sets of features are extracted by a feature extractor. The extracted features are then concatenated into a fused feature vector.

The fused feature vectors for each sub-sequence are then fed into an RNN, such as an Long Short-Term Memory (LSTM) network. The output layer of the LSTM network selects a content label. The output layer may also incorporate external sources of data, such as calendar information, to learn a more accurate multi-modal classification model. A wide array of selectable content labels are possible. In one example, the content labels reflect the format of the written content, such as code, architecture, flowchart, text, checklist, etc. Once the content label is selected, the lighting controller can control one or more luminaires to optimize lighting for the written content. The lighting controller may further incorporate data from other sensors in the environment to optimize the lighting.

Generally, in one aspect, a method for lighting system control is provided. The method includes extracting, via a feature extractor, one or more features from data generated by a smart coated surface. According to an example, the RNN is a Long Short-Term Memory (LSTM) network. According to an example, the method further includes splitting the data into one or more sub-sequences prior to extracting the features.

According to an example, the one or more features include one or more time domain features. In this example, the one or more time domain features may include at least one of a mean, a median, and a skewness.

According to an example, the one or more features include one or more frequency domain features. In this example, the one or more frequency domain features include at least one of a spectral entropy, a median frequency, and a fundamental frequency.

According to an example, the one or more features include one or more spatial domain features. In this example, the one or more spatial domain features include a shape.

The method further includes selecting, via a content classifier, one of a plurality of content labels based on the one or more features and an RNN. According to an example, the selecting of the content label is further based on external data. In this example, the external data may include calendar information. According to a further example, the plurality of content labels includes at least one of code, architecture, text, and flowchart.

The method further includes controlling, via a lighting controller, one or more luminaires based on the content label.

According to an example, the method further includes generating, via the feature extractor, a fused feature vector by concatenating the extracted features. In this example, the selecting of the content label may be further based on the fused feature vector.

Generally, in another aspect, a lighting control system is provided. The lighting control system includes a feature extractor configured to extract one or more features from data generated by a smart coated surface. The lighting control system further includes a content classifier configured to select one of a plurality of content labels based on the one or more features and a recurrent neural network. The lighting control system further includes a lighting controller configured to control one or more luminaires based on the selected content label.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an illustration of a lighting control system, in accordance with an example.

FIG. 2 is a functional block diagram of a lighting control system, in accordance with an example.

FIG. 3 is a schematic of a smart coated surface, in accordance with an example.

FIG. 4 is a schematic of a feature extractor, in accordance with an example.

FIG. 5 is a schematic of a content classifier, in accordance with an example.

FIG. 6 is a flowchart of a Long Short-Term Memory network, in accordance with an example.

FIG. 7 is a flowchart of a method for lighting system control, in accordance with an example.

### DETAILED DESCRIPTION OF EMBODIMENTS

The present disclosure is generally directed to systems and methods for controlling lighting based on written content on smart coated surfaces. The smart coatings generate pressure data based on the written content. A feature extractor then extracts features from the pressure data describing the written content. A content classifier then feeds the features into a recurrent neural network (RNN) to select a content label. A lighting controller then controls luminaires based on the content label. In this way, the system controls the luminaires based on the type of the written content without evaluating or decoding the content itself. For example, the system is able to label the content as text based only on written patterns, without requiring interpretation or analysis of what the text actually says. Accordingly, the content written on the smart coated surface remains private and secure.

The smart coated surface can be any surface, such as a wall or a whiteboard, coated with smart paint. The smart paint consists of an electrically conductive layer which responds with a change in conductance under the presence of people and/or gestures. The change in conductance is converted to an electrical signal and can be processed in processing hardware embedded in the smart coated surface. A wireless transceiver can then be used to transmit the electrical signal to a cloud-based backend for further processing.

When a user writes on a smart coated surface, data, such as a pressure signal, is produced. This pressure signal corresponds to the change in conductance due to the pressure applied by writing on different parts of the smart coated surface. Once generated, the pressure signals are initially pre-processed and normalized. This pre-processing may include filtering the pressure signal and compensating for different pressures produced by different users. This compensation allows for the analysis to only focus on the shape of the pressure signals.

The pressure signals are then split up into a number of sub-sequences. Each sub-sequence has a time duration of 7 seconds. For each sub-sequence I), three sets of features are extracted by a feature extractor. First, the feature extractor extracts statistical features from the time domain such as the mean, median, and skewness of the signal. The next set of features are extracted from the frequency domain such as spectral entropy, median frequency, and fundamental frequency of the signal. The feature extractor also extracts spatial features of the signal using a traditional convolutional neural network (CNN). The spatial features could capture local aspects of the content drawn, like shapes. These extracted features are then concatenated into a fused feature vector.

The fused feature vectors for each sub-sequence I) are then fed into an RNN, such as a Long Short-Term Memory (LSTM) network, configured to select a content label. The LSTM network is a sequential machine learning model which learns as it receives each sequence via a feedback mechanism. A wide array of selectable content labels are possible. In one example, the content labels reflect the format of the written content, such as code, architecture, flowchart, text, etc. In another example, the content labels reflect the meeting occurring to generate the written content, such as brainstorming meeting, focused meeting, fun activity, project kickoff, code review, etc. Once the content label is selected, the lighting controller can control one or more luminaires to optimize lighting for the written content. The lighting controller may further incorporate data from other sensors in the environment to optimize the lighting.

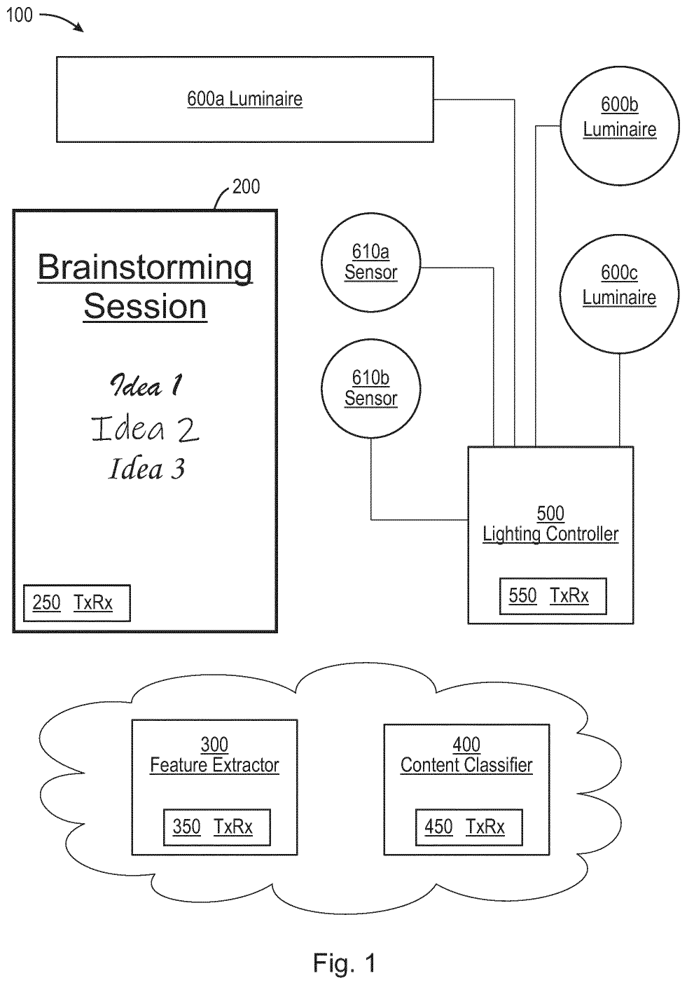

FIG. 1 is an illustration of a lighting control system 100. The lighting control system 100 is implemented in a collaborative working environment, such as a conference room. The conference room is equipped with a smart coated surface 200 in the form of smart paint applied to a wall. The smart coated surface is illuminated by luminaires 600a-600c. In one example, luminaire 600a may be a ceiling mounted fluorescent fixture, while luminaires 600b, 600c are discrete light emitting diode (LED) bulbs. The components of the lighting control system 100 are configured to optimize the luminaires 600a-600c for the type of content being written on the smart coated surface 200 by without requiring analysis or interpretation of the written contents itself.

The smart coated surface 200 of FIG. 1 is used for a brainstorming session. As part of the brainstorming session, three different individuals have contributed to the list of ideas on the smart coated surface 200, as illustrated by the three different fonts used. Information regarding the written content is transmitted to the cloud via transceiver 250. This information is processed by the feature extractor 300 and content classifier 400. The content classifier 400 then transmits, via transceiver 450, the processed information to lighting controller 500. The lighting controller 500 optimizes the luminaires 600a-600c based on the processed information, as well as additional information received sensors 610a, 610b. The sensors 610a, 610b may be configured to monitor movement or occupancy of the conference room, as well as other relevant information.

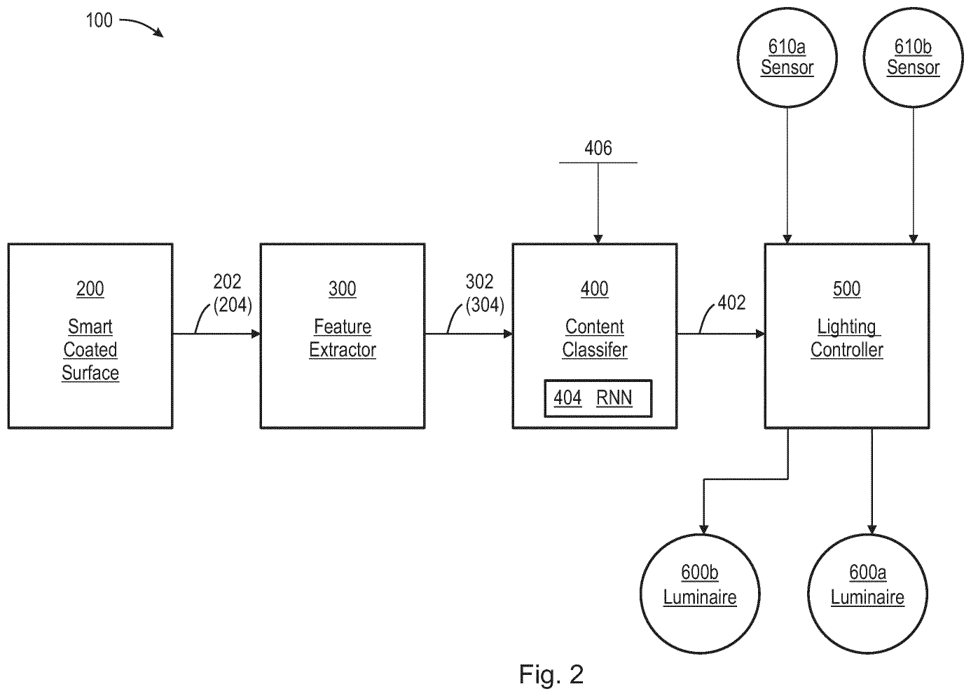

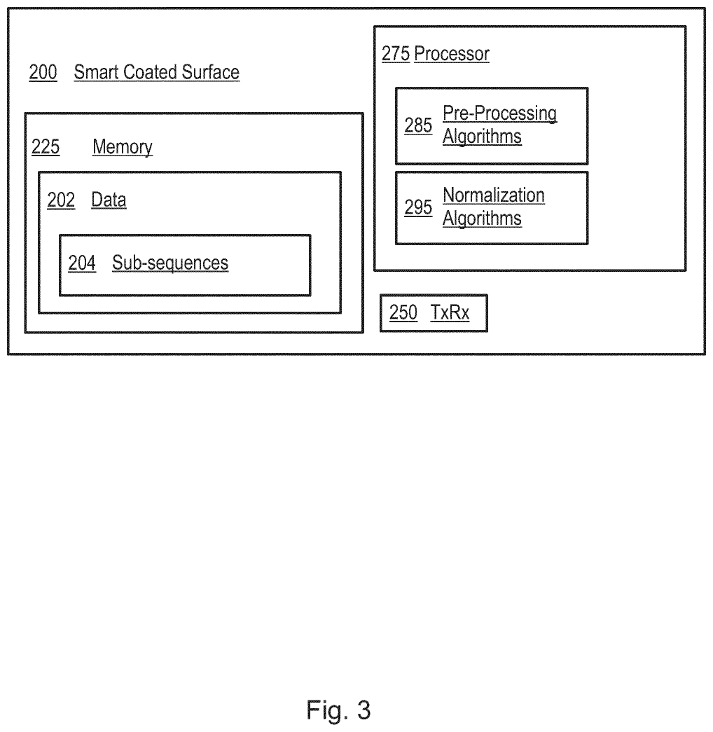

FIG. 2 is a functional block diagram of a lighting control system 100. As shown in FIG. 2, and described above, the lighting control system includes a smart coated surface 200. Aspects of the smart coated surface 200 are shown in more detail in FIG. 3. The smart coated surface 200 further includes a memory 225, a transceiver 250, and a processor 275. The smart coated surface 200 can be any surface, such as a wall or a whiteboard, coated with smart paint. The smart paint consists of an electrically conductive layer which responds with a change in conductance under the presence of people and/or gestures. The change in conductance is converted to an electrical signal and can be processed by processor 275 embedded in the smart coated surface 200.

When a user writes on a smart coated surface, data 202, such as a pressure signal, is produced. This data 202 corresponds to the change in conductance due to the pressure applied by writing on different parts of the surface. The data 202 can be mathematically represented as (Sₓ(t), S_{y}(t)), where Sₓ(t) is the change in conductance in the X direction over time, and S_{y}(t) is the change in conductance in the Y direction over time. As the user writes on the smart coated surface 200, the generated data 202 changes in characteristic ways.

The processor 275 pre-processes the data 202 via pre-processing algorithms 285. The processor 275 also normalizes the data via normalization algorithms 295. The pre-processing algorithms 285 may include filtering the data 202 and compensating for different pressures produced by different users. This compensation can allow for the analysis to focus on the shape (e.g., flow-charts, different shapes within a flow-chart, architecture components, diagrams, class diagrams, etc.) of the data 202. The pre-processed data 202 is then split up into a number of sub-sequences 204 (each having a time duration of T seconds) according to Equation 1 below:

$$D 1 = [ {S}_{x} ( 1 ) , {S}_{y} ( 1 ) ] , [ {S}_{x} ( 2 ) , {S}_{y} ( 2 ) ] , \text{} … , [ {S}_{x} ( T ) , {S}_{y} ( T ) ] , D 2 = [ {S}_{x} ( T + 1 ) , {S}_{y} ( T + 1 ) ] , [ {S}_{x} ( T + 2 ) , {S}_{y} ( T + 2 ) ] , … , [ {S}_{x} ( 2 T ) , {S}_{y} ( 2 T ) ] ) \qquad ( 1 )$$

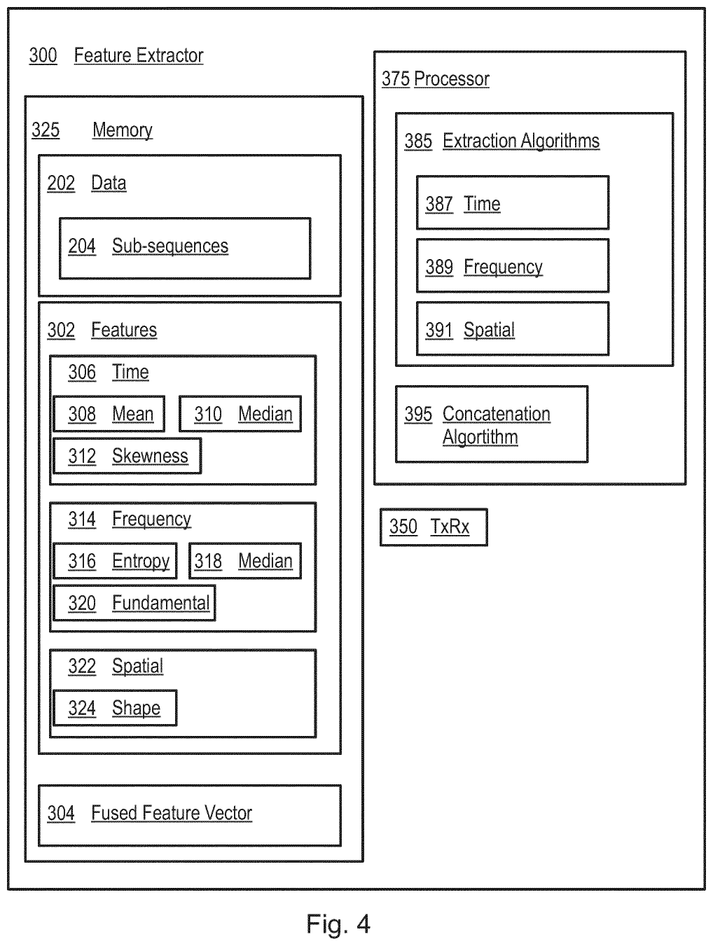

The data 202 (and the sub-sequences 204 of the data 202) are then provided to feature extractor 300. Aspects of the feature extractor 300 are shown in more detail in FIG. 4. The feature extractor 300 includes a memory 325, a transceiver 350, and a processor 375. For each sub-sequence 204 (D1, D2, etc.) of data 202, one or more features 302 can be extracted by the processor 375 of the feature extractor 300 executing one or more extraction algorithms 385. In some embodiments, for each sub-sequence 204 (D1, D2, etc.) of data 202, up to three sets of features 302 are extracted by the processor 375 of the feature extractor 300 executing one or more extraction algorithms 385. For example, first, the feature extractor 300 extracts statistical features from the time domain 306 such as the mean 308, median 310, and skewness 312 of the sub-sequence 204 using time-related feature extraction algorithms 387. The feature extractor 300 may then extract features from the frequency domain 314 such as spectral entropy 316, median frequency 318, and fundamental frequency 320 of the sub-sequence 204 using frequency-related extraction algorithms 389. The feature extractor 300 may also extracts spatial features 322 of the sub-sequence 204 using spatial-related extraction algorithms 391, such as a traditional CNN. The spatial features 322 could capture local aspects of the content drawn, like shapes 324. The shapes 324, can include but are not limited to, shapes within or indicating a flow-chart (e.g., oval, rectangle, diamond, arrow, or any shape or element of a flow-chart), a flow-chart, architecture components, diagrams, and/or class diagrams. Once extracted, each of these features may then be concatenated into a fused feature vector 304 via a concatenation algorithm 395.

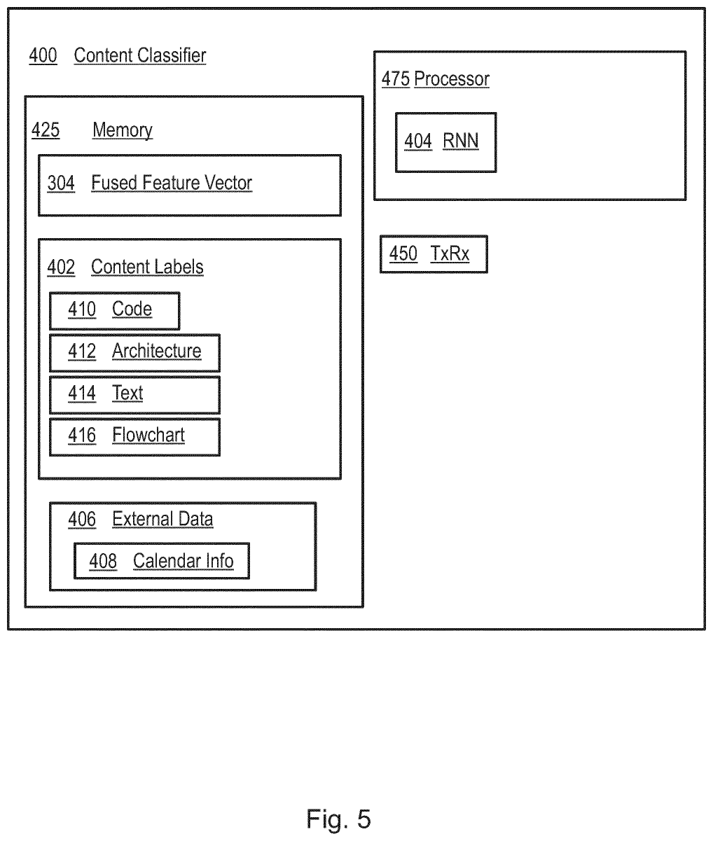

The extracted features 302 (such as in the form of a fused feature vector 304) are then provided to content classifier 400. Aspects of the content classifier at shown in more detail in FIG. 5. The content classifier 400 includes a memory 425, a transceiver 450, and a processor 475. The content classifier 400 feeds the received fused feature vector 304 for each sub-sequence 204 into an RNN 404, such as a Long Short-Term Memory (LSTM) network. Based on the series of fused feature vectors 304, the RNN 404 selects one of a plurality of content labels 402 stored in the memory of the content classifier 400. The content labels 402 reflect the type of content written on the smart coated surface, rather than a value, meaning, or interpretation of the content. For instance, the content classifier 400 (and the system 100 as a whole) may be configured to recognize text 414 written on the smart coated surface by recognizing patterns in the extracted features 300, rather than decoding the meaning of the letters, words, numbers and/or punctuation of the text 414. In this way, the system 100 is able to securely determine the type of content on the smart coated surface 200, and generate a corresponding content label 402.

A wide array of selectable content labels 402 are possible. In one example, the content labels 402 reflect the format of the written content, such as code 410, architecture 412, flowchart 416, text 414, checklist 418, etc. In another example, the content labels 402 reflect the type of meeting occurring to generate the written content, such as brainstorming meeting, focused meeting, fun activity, project kickoff, code review, etc. A content label 402 could also be selected to indicate no written content is present on the smart coated surface 200.

In a further example, content classifier 400 further bases the selection of the content label 402 based on external data 406. This external data 406 may be received via transceiver 450, and stored in memory 425. In one example, the external data 406 includes calendar information 408 regarding the conference room within which the smart coated surface 200 is located. For instance, the calendar information 408 may contain a detailed schedule of meetings to be held in the conference room, including participants (including their job, department, specialty areas, current workload, etc.), meeting agenda, and more. The RNN 404 can use this external data 406 to modify their selection of a content label 402. For instance, if the calendar information 408 shows that the conference room is currently being used for a meeting involving software engineers and computer programmers, and the agenda includes the term “code review,” the written content on the smart coated surface 200 is more likely to be computer code 410 than in a meeting attended by marketing professionals. This external data 406 is used to adjust weights and/biases of the RNN 404 accordingly.

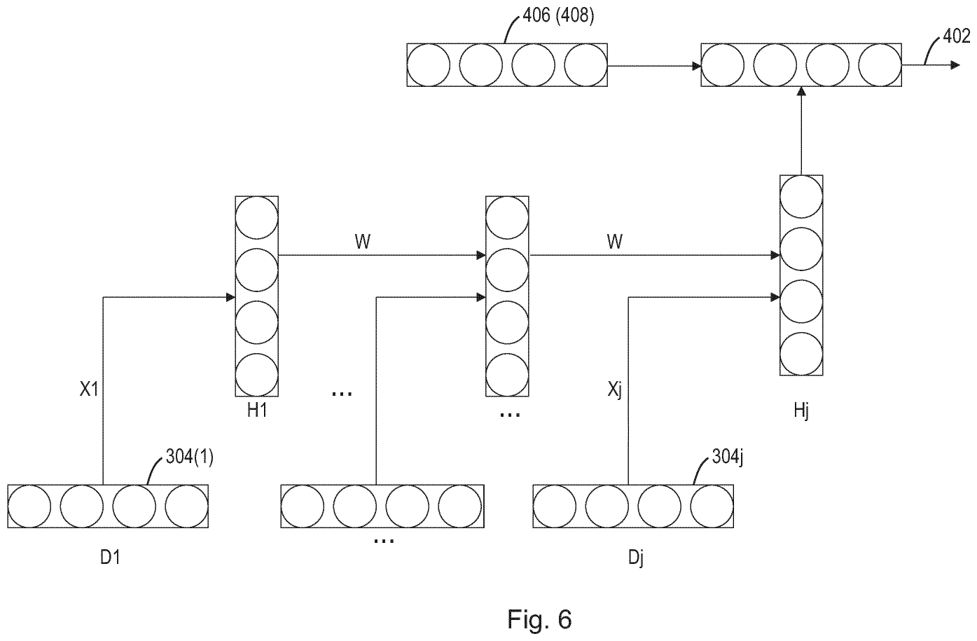

An example LSTM network structure is illustrated in FIG. 6. The LSTM network is a sequential machine learning model which learns as it receives each fused feature vector 304 via a feedback mechanism. To learn the inherent patterns associated with the different content labels 402, at each time period j, the output W of the hidden layer Hⱼ of the LSTM network is propagated back to the hidden layer together with the next input xⱼ₊₁ at the next point in time j+1. The last output Wₙ will be fed to the output layer 420 to select a content label 402. The number of neurons in an output layer 420 may correspond to the plurality of selectable content labels 402. As described above, the output layer 420 may also incorporate external data 406, such as calendar information 408, to learn a more accurate multi-modal classification model. Via gradient-based backpropagation through time, the weights of the edges in the hidden layer are adjusted each point of time. After several epochs of training, the content classification model is obtained.

Once selected, the content label 402 is provided to lighting controller 500. The lighting controller 500 is configured to control one or more luminaires 600a, 600b to optimize lighting for the written content of the smart coated surface 200. The lighting controller 500 may further incorporate data from other sensors 610a, 610b in the environment to optimize the lighting. The sensors 610a, 610b may be configured to monitor movement or occupancy of the conference room, as well as other relevant information. For instance, if the sensors 610a, 610b generate information indicative of an empty room, the lighting controller 500 may power off or dim the luminaires 600a, 600b regardless of the selected content label 402.

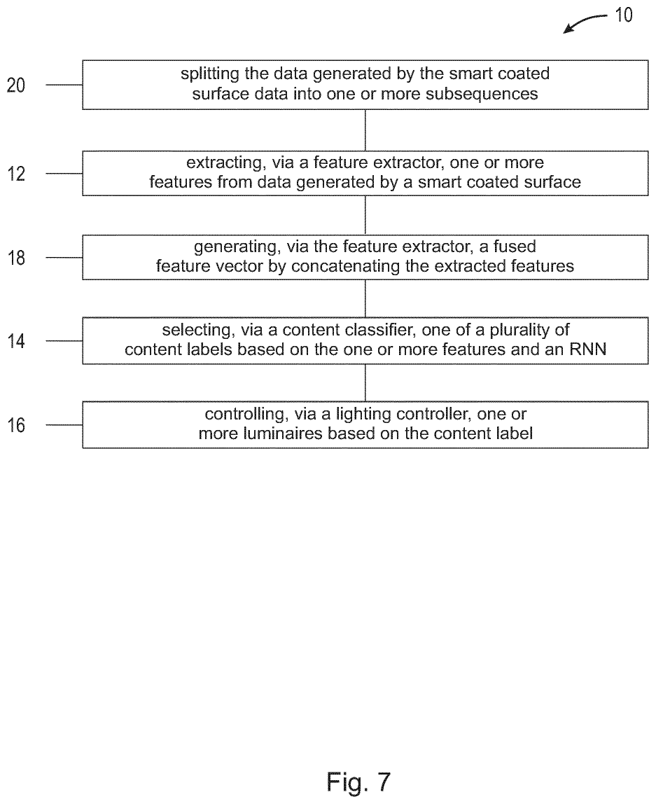

FIG. 7 is a flowchart of a method 10 for lighting system control. The method 10 includes extracting 12, via a feature extractor, one or more features from data generated by a smart coated surface. The method 10 further includes selecting 14, via a content classifier, one of a plurality of content labels based on the one or more features and an RNN. The method 10 further includes controlling 16, via a lighting controller, one or more luminaires based on the content label. According to an example, the method 10 further includes generating 18, via the feature extractor, a fused feature vector by concatenating the extracted features. According to a further example, the method 10 further includes splitting 20 the data into one or more sub-sequences prior to extracting the features.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method for lighting system control, comprising:
extracting, via a feature extractor, one or more features from data generated by a smart coated surface, the data corresponding to content on the smart coated surface;
selecting, via a content classifier, one of a plurality of content labels for the data based on the one or more features and an output of a recurrent neural network (RNN), wherein the selected content label indicates a type of content provided on the smart coated surface; and
controlling, via a lighting controller, one or more luminaires based on the content label.

2. The method of claim 1, wherein the recurrent neural network is a Long Short-Term Memory (LTSM) network.

3. The method of claim 1, further comprising generating, via the feature extractor, a fused feature vector by concatenating the extracted features.

4. The method of claim 3, wherein the selecting of the content label is further based on the fused feature vector.

5. The method of claim 1, wherein the one or more features include one or more time domain features.

6. The method of claim 5, wherein the one or more time domain features include at least one of a mean, a median, and a skewness.

7. The method of claim 1, wherein the one or more features include one or more frequency domain features.

8. The method of claim 7, wherein the one or more frequency domain features include at least one of a spectral entropy, a median frequency, and a fundamental frequency.

9. The method of claim 1, wherein the one or more features include one or more spatial domain features.

10. The method of claim 9, wherein the one or more spatial domain features include a shape.

11. The method of claim 1, further comprising splitting the data into one or more sub-sequences prior to extracting the features.

12. The method of claim 1, wherein the selecting of the content label is further based on external data.

13. The method of claim 12, wherein the external data comprises calendar information.

14. The method of claim 1, wherein the plurality of content labels includes at least one of code, architecture, text, and flowchart.

15. A lighting control system, comprising:
a feature extractor configured to extract one or more features from data generated by a smart coated surface, the data corresponding to content on the smart coated surface;
a content classifier configured to select one of a plurality of content labels based on the one or more features and an output of a recurrent neural network of the content classifier, wherein the selected content label indicates a type of content on the smart coated surface; and
a lighting controller configured to control one or more luminaires based on the selected content label.
